(19) United States
(12) Patent Application Publication
(10) Pub. No.: US 2024/0328012 A1
(43) Pub. Date: Oct. 3, 2024

(54) PHOTOCATALYST PRODUCTION METHOD, AND HYDROGEN AND OXYGEN PRODUCTION METHOD USING SAID PHOTOCATALYST

(71) Applicants: MITSUBISHI CHEMICAL CORPORATION, Tokyo (JP); SHINSHU UNIVERSITY, Matsumoto City (JP); JAPAN TECHNOLOGICAL RESEARCH ASSOCIATION OF ARTIFICIAL PHOTOSYNTHETIC CHEMICAL PROCESS, Tokyo (JP)

(72) Inventors: Hiroaki YOSHIDA, Tokyo (JP); Susumu TSUTSUMINAI, Tokyo (JP); Nobuko KARIYA, Tokyo (JP); Kazunari DOMEN, Nagano City (JP); Takashi HISATOMI, Nagano City (JP); Lihua LIN, Nagano City (JP); Xiaoping TAO, Nagano City (JP); Xizhuang LIANG, Nagano City (JP)

(73) Assignees: MITSUBISHI CHEMICAL CORPORATION, Tokyo (JP); SHINSHU UNIVERSITY, Matsumoto City (JP); JAPAN TECHNOLOGICAL RESEARCH ASSOCIATION OF ARTIFICIAL PHOTOSYNTHETIC CHEMICAL PROCESS, Tokyo (JP)

(21) Appl. No.: 18/743,226

(22) Filed: Jun. 14, 2024

Related U.S. Application Data
(63) Continuation of application No. PCT/JP2022/046448, filed on Dec. 16, 2022.

(30) Foreign Application Priority Data
Dec. 16, 2021 (JP) 2021-204414
Dec. 14, 2022 (JP) 2022-199802

(51) Int. Cl. C25B 11/087; B01J 19/12; C25B 1/04; C25B 1/55; C25B 9/50

(52) U.S. Cl. CPC C25B 11/087; B01J 19/127; C25B 1/04; C25B 1/55; C25B 9/50; B01J 2219/089; B01J 2219/0892; B01J 2219/12

(57) ABSTRACT

Provided is a photocatalyst with significantly enhanced water splitting performance in YTOS or in a composition in which the yttrium element of YTOS has been replaced with another element. Also provided is a method for producing a photocatalyst that has a composition represented by the following general formula (I), the method including mixing, with a raw material of the photocatalyst, a flux component at a mass ratio of 0.01 times to 50 times, the flux component being composed of one or more chlorides and/or iodides of at least one selected from Li, Na, K, Rb, Mg, Ca, Sr, and Ba, and calcining a resultant product at 450° C. to 1050° C.:

MₐTi_{b}O_{c}S_{d} (I)

(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).

### CROSS-REFERENCE TO RELATED APPLICATIONS

This application is a Continuation of PCT International Application No. PCT/JP2022/046448 filed in Japan on Dec. 16, 2022, which claims the benefit of Patent Application No. 2021-204414 filed in Japan on Dec. 16, 2021 and Patent Application No. 2022-199802 filed in Japan on Dec. 14, 2022, the entire contents of which are hereby incorporated by reference.

### TECHNICAL FIELD

The present invention relates to a method for producing a photocatalyst and to a method for producing hydrogen and oxygen with use of the photocatalyst.

### BACKGROUND ART

From the perspective of aiming to suppress global warming and move away from depleting fossil resource dependence, the development of high-performance light energy conversion systems that use solar energy as renewable energy has sharply increased in importance in recent years. Among such systems, the technology for using solar energy to split water and produce hydrogen can be utilized not only as a current technology for refining petroleum and supplying raw materials such as ammonia and methanol but also as an energy carrier for fuel cells. Social demands for the development of the technology are increasing.

The water splitting reaction of a photocatalyst has been extensively studied for a long time.

The water splitting reaction in an acidic aqueous solution on photocatalyst particles is inferred as follows:

H₂O+2h⁺→½O₂+2H⁺ (1)

2H⁺+2e⁻→H₂ (2)

As a photocatalyst that causes such a reaction, for example, Y₂Ti₂O₅S₂ disclosed in Patent Literature 1 (which may hereinafter be abbreviated as “YTOS”) is known.

### CITATION LIST

### Patent Literature

### [Patent Literature 1]

Japanese Patent Application Publication, Tokukai, No. 2020-138188

### SUMMARY OF INVENTION

### Technical Problem

However, when the yttrium element of YTOS is replaced with another element, the water splitting performance is unfortunately extremely low so as not to be taken into account. Therefore, conventionally, few attempts have been made to improve the control of absorption wavelengths and various characteristics, such as water splitting performance, durability, and strength, by replacing yttrium elements in YTOS with other elements.

An object of the present invention is to provide a photocatalyst with significantly enhanced water splitting performance in YTOS or in a composition in which the yttrium element of YTOS has been replaced with another element.

### Solution to Problem

The inventors of the present invention conducted diligent research to attain the object and, as a result, found that for the lanthanoid elements containing Y, a novel photocatalyst with excellent photocatalytic activity in the same composition can be obtained by adding a chloride or an iodide of a specific element as a flux component and performing calcination and that using this photocatalyst makes it possible to more efficiently produce hydrogen and oxygen. Thus, the inventors have reached the present invention.

Specifically, aspects of the present invention are summarized as follows.

A photocatalyst production method in accordance with an aspect of the present invention is a method for producing a photocatalyst having a composition represented by the following general formula (I), including
mixing, with a raw material of the photocatalyst, a flux component at a mass ratio of 0.01 times to 50 times, the flux component being composed of one or more chlorides and/or iodides of at least one selected from Li, Na, K, Rb, Mg, Ca, Sr, and Ba, and calcining a resultant product at 450° C. to 1050° C.:

MₐTi_{b}O_{c}S_{d} (I)

(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).

A photocatalyst in accordance with an aspect of the present invention is a photocatalyst having a composition represented by the following general formula (I), wherein the photocatalyst generates hydrogen in an amount of 100 μmol or more per hour by irradiating the photocatalyst with light using a 300 W xenon lamp (λ>420 nm) in an aqueous methanol solution having a 10 volume % concentration or a 20 mmol/L Na₂S—Na₂SO₃ aqueous buffer solution:

MₐTi_{b}O_{c}S_{d} (I)

(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).

A photocatalyst in accordance with an aspect of the present invention is a photocatalyst having a composition represented by the following general formula (I), wherein a surface elemental composition ratio of S to Ti (S/Ti) as obtained by XPS measurement is in a range of 0.50 to 1.08:

MₐTi_{b}O_{c}S_{d} (I)

(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).

An embodiment of the present invention provides a photocatalyst with significantly enhanced water splitting performance in YTOS or in a composition in which the yttrium element of YTOS has been replaced with another element.

With use of the photocatalyst in accordance with an embodiment of the present invention, it is possible to efficiently perform complete water splitting and produce hydrogen and oxygen.

### Advantageous Effects of Invention

An embodiment of the present invention provides a photocatalyst with significantly enhanced water splitting performance in YTOS or in a composition in which the yttrium element of YTOS has been replaced with another element.

With use of the photocatalyst in accordance with an embodiment of the present invention, it is possible to efficiently perform complete water splitting and produce hydrogen and oxygen.

### DESCRIPTION OF EMBODIMENTS

The following description will discuss an embodiment of the present invention in detail. However, the present invention is not limited to the description, and can be altered as appropriate, provided that such alteration does not go beyond the gist of the present invention. In the present specification, when a range of numerical values or physical property values is expressed with “to” between the values, such values shall be assumed to be included in the range.

A photocatalyst production method in accordance with an embodiment of the present invention is a method for producing a photocatalyst having a composition represented by a general formula (I) below, including mixing, with a raw material of the photocatalyst, a flux component at a mass ratio of 0.01 times to 50 times, the flux component being composed of one or more chlorides and/or iodides of at least one selected from Li, Na, K, Rb, Mg, Ca, Sr, and Ba, and calcining a resultant product at 450° C. to 1050° C.

A photocatalyst in accordance with an embodiment of the present invention is a photocatalyst having a composition represented by the general formula (I) below, in which the photocatalyst generates hydrogen in an amount of 100 μmol or more per hour by irradiating the photocatalyst with light using a 300 W xenon lamp (λ>420 nm) in an aqueous methanol solution having a 10 volume % concentration or a 20 mmol/L Na₂S—Na₂SO₃ aqueous buffer solution.

MₐTi_{b}O_{c}S_{d} (I)

(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).

A photocatalyst in accordance with an embodiment of the present invention is typically produced by a photocatalyst production method in accordance with an embodiment of the present invention.

Hereinafter, the photocatalyst in accordance with an embodiment of the present invention, including a photocatalyst produced by the photocatalyst production method in accordance with an embodiment of the present invention, will be referred to as “photocatalyst in accordance with an embodiment of the present invention”.

### [Composition of Photocatalyst]

The photocatalyst in accordance with an embodiment of the present invention has a composition represented by the following general formula (I):

MₐTi_{b}O_{c}S_{d} (I)

(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).

That is, where the number b of moles of Ti as a reference is 2, the molar ratio is that a is 1.7 to 2.3, c is 4.7 to 5.3, and d is 1.7 to 2.3.

With respect to the number b of moles of Ti being 2, a, c, and d are preferably 1.8 to 2.2, 4.8 to 5.2, and 1.8 to 2.2, respectively, and more preferably 1.85 to 2.15, 4.85 to 5.15, and 1.85 to 2.15, respectively.

M in the formula (I) is one or more selected from Pr, Nd, Pm, Sm, Eu, Gd, Tb, Dy, Ho, Er, Tm, and Y. Pr, Nd, Pm, Sm, Eu, Gd, Tb, Dy, Ho, Er, and Tm are lanthanoid (Ln) elements. In the M₂Ti₂O₅S₂ structure, these Ln elements and the Y element have little electronic effect on the hybrid orbitals composed of Ti, O, and S. In addition, according to the lanthanoid elements, the outermost shell of the electrons do not change but only the number of electrons of the 4f orbit on the inside change. Thus, the effect of the entrance of the Ln elements into the structure is small. For this reason, substantially the same photocatalytic activity can be expected when any of the Ln elements is used. While the elements in accordance with an embodiment of the present invention are therefore considered to be applicable to these Ln elements, these Ln elements are preferably one or more of, for example, Gd, Sm, Er, Dy, Y, Nd, and Ho and more preferably Gd, Sm, Er, Dy, and Y, from the perspective that crystal particles obtained by the addition of these elements have a small particle size and that the surface area of the photocatalyst can be easily secured.

### [Method for Producing Photocatalyst]

The photocatalyst in accordance with an embodiment of the present invention can be produced by weighing the raw materials that are to be the M source, the Ti source, the O source, and the S source, in such a manner as to satisfy the formula (I), sufficiently mixing the materials, mixing, with the resultant mixture (photocatalyst material), a certain flux component at a certain ratio, and calcining the resultant product at a certain temperature.

As the M source, one or more of, for example, M₂O₃, M₂O₂S, M₂S₃, M, and MCl₃ can be used. It should be noted here that M₂O₃ and M₂O₂S are also O sources. In addition, M₂S₃ and M₂O₂S are also S sources.

That is, for example, among the M sources, one or more of, for example, Y₂O₃, Y₂O₂S, Y₂S₃, Y, and YCl₃ can be used as the Y source. It should be noted here that Y₂O₃ and Y₂O₂S are also O sources. Y₂S₃ and Y₂O₂S are also S sources.

Among the M sources, as the Gd source, one or more of, for example, Gd₂O₃, Gd₂O₂S, Gd₂S₃, Gd, and GdCl₃ can be used. It should be noted here that Gd₂O₃ and Gd₂O₂S are also O sources. In addition, Gd₂S₃ and Gd₂O₂S are also S sources.

In addition, among the M sources, as the Sm source, one or more of, for example, Sm₂O₃, Sm₂O₂S, Sm₂S₃, Sm, and SmCl₃ can be used. It should be noted here that Sm₂O₃ and Sm₂O₂S are also O sources. In addition, Sm₂S₃ and Sm₂O₂S are also S sources.

In addition, among the M sources, as the Er source, one or more of, for example, Er₂O₃, Er₂O₂S, Er₂S₃, Er, and ErCl₃ can be used. It should be noted here that Er₂O₃ and Er₂O₂S are also O sources. In addition, Er₂S₃ and Er₂O₂S are also S sources.

In addition, among the M source, as the Dy source, one or more of, for example, Dy₂O₃, Dy₂O₂S, Dy₂S₃, Dy, and DyCl₃ can be used. It should be noted here that Dy₂O₃ and Dy₂O₂S are also O sources. In addition, Dy₂S₃ and Dy₂O₂S are also S sources.

As the Ti source, one or more of, for example, TiO₂, TiS₂, and Ti can be used. It should be noted here that TiO₂ is also an O source. In addition, TiS₂ is also an S source.

As described above, the O source is preferably also the M source and the Ti source.

As the S source, one or more of, for example, S and H₂S can be used. In doing so, a method for performing a reaction by circulating, for example, H₂S as a gas is one of the preferable aspects for producing the photocatalyst in accordance with an embodiment of the present invention. In addition, as described above, M₂S₃, M₂O₂S, and TiS₂ are also S sources.

Mixing these photocatalysts causes the contamination of air and a small amount of moisture and thus leads to impurities such as an oxide phase. Therefore, these photocatalysts are preferably mixed in a glove box or the like having a dew point of −20° C. or lower under an inert gas atmosphere such as nitrogen.

In an embodiment of the present invention, one or more flux components selected from the chlorides and/or iodides of Li, Na, K, Rb, Mg, Ca, Sr, and Ba is mixed with the photocatalyst material obtained as described above.

Specific examples of the flux component are LiCl, NaCl, KCl, RbCl₂, MgCl₂, CaCl₂), SrCl₂, BaCl₂, LiI, NaI, KI, RbI₂, MgI₂, CaI₂, SiI₂, and BaI₂.

The flux component may be one of or two or more of these chlorides and/or iodides.

When two or more of the flux components are used, it is preferable to prepare a mixture of two or more of these flux components in advance and mix the mixture with a photocatalyst material, because, in this way, uniform dispersion into the raw material is easy. In this case, a combination of the flux components mixed is preferably a combination of chlorides together and a combination of iodides together, and it is preferable to use a mixed flux component which is obtained by mixing LiCl and CaCl₂, mixing LiCl and KCl, mixing LiCl and NaCl, mixing MgCl₂ and CaCl₂, mixing MgCl₂ and SrCl₂, mixing MgCl₂ and BaCl₂, mixing LiCl and MgCl₂ at a “1:0.1 to 100” ratio, in terms of molar ratio.

The flux component is mixed with the photocatalyst material in an amount of 0.01 times to 50 times, in terms of mass ratio, with respect to the photocatalyst material.

When the flux component is less than 0.01 times the mass of the photocatalyst material, the flux component melted at the calcination is not spread through the entire photocatalyst material. This prevents the reaction from sufficiently proceeding. Thus, the purity of the target photocatalyst decreases, and good photocatalytic activity is not obtained. Thus, the mass ratio of the flux component to the photocatalyst material in the mixture is 0.01 times or more, preferably 0.1 times or more, and more preferably 0.5 times or more. In contrast, when the mass ratio of the flux component in the mixture is high, there is no negative effect on the photocatalyst performance. However, when the reaction vessel is of a certain volume, a large amount of the flux component causes the encapsulation amount of the photocatalyst material to be low. Thus, the amount of the target photocatalyst also becomes small. Thus, the mass ratio of the flux component in the mixture in handling is 50 times or less, preferably 40 times or less, and more preferably 30 times or less.

Mixing the flux component with the photocatalyst material, as in the case of mixing the photocatalyst materials together, causes the contamination of air and a small amount of moisture and thus leads to impurities such as an oxide phase. Therefore, the mixing is preferably performed in a glove box or the like having a dew point of −20° C. or lower under an inert gas atmosphere such as nitrogen.

In an embodiment of the present invention, the calcination after mixing the flux component with the photocatalyst material is performed at a temperature of 450° C. to 1050° C. If this calcination temperature is excessively low, the flux component added does not melt and does not function as a flux. This prevents the reaction from sufficiently proceeding. Thus, the purity of the target photocatalyst decreases, and good photocatalytic activity is not obtained. Thus, the calcination temperature is 450° C. or higher, preferably 500° C. or higher, and more preferably 550° C. or higher. In contrast, when the calcination temperature is excessively high, an oxide impurity phase is generated so as to reduce the purity and the particles of the photocatalyst grow and coarsen. This decreases the surface area of the particles and decreases the particle surfaces used for the photocatalyst reaction, and therefore results in a reduction in the photocatalytic activity. Thus, the calcination temperature is 1050° C. or lower, preferably 1000° C. or lower, and more preferably 980° C. or lower.

Although varying depending on the calcination temperature, an excessively short calcination time causes an impurity phase to be generated and decreases the purity of the target photocatalyst, and therefore may make it impossible to sufficiently improve the photocatalytic activity, and an excessively long calcination time causes the particles of the photocatalyst to grow and coarsen, and thus decreases the surface area of the particles and decreases the particle surfaces used for the photocatalyst reaction, and therefore may make it impossible to sufficiently improve the photocatalytic activity. Thus, the calcination time is 0.05 hours or more, particularly 0.5 hours to 500 hours, and particularly preferably 300 hours or less.

A more preferable calcination condition is that the calcination temperature is 600° C. to 900° C. and the calcination time is 1 hour to 200 hours, particularly 3 hours to 100 hours.

Although the calcination atmosphere is not particularly limited, the calcination is preferably performed in a vacuum from the perspective of preventing a side reaction.

The photocatalyst obtained as a result of the calcination, for oxidizing and removing excess sulfur as necessary, can be subjected to a heat treatment in which the photocatalyst is heated in the air at a temperature of 100° C. to 300° C. for approximately 0.1 hours to 3 hours. After the heat treatment, it is preferable that the resultant product is washed with water to remove the sulfur oxide and perform liquid-solid separation of the photocatalyst.

As necessary, the resultant photocatalyst can be subjected to an acid treatment in which the photocatalyst is brought into contact with an acid such as sulfuric acid, nitric acid, or aqua regia in an amount of approximately 20 mass % to 80 mass %. The acid treatment can remove impurities on the surfaces of photocatalyst particles.

As necessary, the resultant photocatalyst can also be subjected to a sizing treatment such as pulverization and classification.

The particle size after the pulverization is, although not particularly limited, preferably 1 μm or more for easy handling. A particle size of 20 μm or less increases the surface area of the catalyst so as to improve the catalytic activity, and is therefore preferable. The particle size is calculated by, for example, capturing a photograph with use of an SEM, randomly select approximately 50 particles, measuring the diameters, and obtaining the average value. If the particles after the pulverization are considerably not spherical, it is possible to measure and calculate the particle size by the area-equivalent diameter from the photograph.

The resultant photocatalyst, as necessary, can also be suspended in a promoter-containing solution and subjected to a microwave (MW) treatment. In some cases, the MW treatment allows an evaluation photocatalyst described later to be prepared in a short period of time. For the MW-treatment, “Microwave synthesis Reactor Monowave 300” manufactured by Anton Paar, for example, can be used, and recommended conditions can be selected as appropriate.

The photocatalyst in accordance with an embodiment of the present invention thus produced has excellent photocatalytic activity and, as clearly indicated by the results in Example discussed later, is capable of generating hydrogen in an amount of 100 μmol or more per hour, preferably 105 μmol or more, and more preferably 120 μmol or more by irradiating the photocatalyst with light using a 300 W xenon lamp (λ>420 nm) in an aqueous methanol solution having a 10 volume % concentration or a 20 mmol/L Na₂S—Na₂SO₃ aqueous buffer solution. While these amounts of hydrogen generation can be satisfied by either method, it is more preferable to satisfy these amounts by an aqueous methanol solution having a 10 volume % concentration.

### [Application]

A photocatalyst in accordance with an embodiment of the present invention is effective as a water splitting photocatalyst, exhibits particularly high photocatalytic activity, and can completely split water as a photocatalyst that is capable of completely splitting water with a single electrode, that is, without a counter electrode.

### [Method and Device for Producing Hydrogen and Oxygen]

The hydrogen and oxygen production method and device in accordance with an embodiment of the present invention use the photocatalyst in accordance with an embodiment of the present invention to generate hydrogen and oxygen without the use of a sacrificial reagent. Using the photocatalyst in accordance with an embodiment of the present invention also makes it possible to generate hydrogen and oxygen on the same electrode. In an embodiment of the present invention, the term “electrode” is used to refer to a laminate which is provided with a photocatalyst layer containing, on a base material, the photocatalyst in accordance with an embodiment of the present invention or a complex which contains the photocatalyst in accordance with an embodiment of the present invention.

Although the photocatalyst in accordance with an embodiment of the present invention exhibit sufficient photocatalytic activity by itself, the photocatalyst is preferably used in combination with a promoter.

Examples of the promoter includes an oxidation reaction promoter (oxygen generation side) and a reduction reaction promoter (hydrogen generation side), and it is preferable to support one or both of these on the YTMOS. Preferable examples of the oxidation reaction promoter include any of the metals of the groups 2 through 14 in the periodic table, intermetallic compounds of the metals, and an alloy of the metals, and oxides, complex oxides, nitrides, oxynitrides, sulfides, and oxysulfides thereof, and a mixture thereof. It should be noted here that the “intermetallic compound” refers to a compound formed from two or more metal elements, and the component atomic ratio that constitutes the intermetallic compound is not necessarily a stoichiometric ratio but has a wide composition range. The “oxides, complex oxides, nitrides, oxynitrides, sulfides, and oxysulfides thereof” refer to oxides, complex oxides, nitrides, oxynitrides, sulfides, and oxysulfides of the metals of the groups 2 through 14 in the periodic table, the intermetallic compounds of the metals, or the alloy. The “mixture thereof” refers to a mixture of two or more of the above examples the compounds.

Preferable examples of the oxidation reaction promoter include metals of Mg, Ti, Mn, Fe, Co, Ni, Cu, Ga, Ru, Rh, Pd, Ag, Cd, In, Ce, Ta, W, Ir, Pt, and Pb, and oxides and complex oxides thereof. More preferable examples of the oxidation reaction promoter include metals of Mn, Co, Ni, Ru, Rh, and Ir, and oxides and complex oxides thereof. Even more preferable examples of the oxidation reaction promoter include Ir, MnO, MnO₂, Mn₂O₃, Mn₃O₄, and CoO, Co₃O₄, NiCo₂O₄, RuO₂, Rh₂O₃, and IrO₂.

Preferable examples of the reduction reaction promoter include any of the metals of group 3 to 13 in the periodic table, intermetallic compounds of the metals, and an alloy of the metals, and oxides, complex oxides, oxynitrides, sulfides, oxysulfides, carbides, and nitrides thereof, and a mixture thereof. It should be noted here that the “intermetallic compound” is as defined above. The “oxides, complex oxides, oxynitrides, sulfides, oxysulfides, carbides, and nitrides thereof” refer to oxides, complex oxides, oxynitrides, sulfides, oxysulfides, carbides, and nitrides of the metals of group 3 to 13 in the periodic table, the intermetallic compounds of the metals, or the alloy. The “mixture thereof” refers to a mixture of two or more of the above examples the compounds.

Preferable examples of the reduction reaction promoter include Pt, Pd, Rh, Ru, Ni, Au, Fe, NiO, RuO₂, IrO₂, and Rh₂O₃, a Cr—Rh complex oxide, core-shell Rh/Cr₂O₃, and Pt/Cr₂O₃.

As a supporting amount of the promoter described above, the metal supporting amount of the oxidation reaction promoter is, although not particularly limited, typically 0.01 mass % to 5 mass %, preferably up to 4 mass %, and more preferably 0.05 mass % to 3 mass %, with respect to YTMOS as a reference (100 mass %). The metal supporting amount of the reduction reaction promoter is, although not particularly limited, typically 0.01 mass % to 20 mass %, preferably up to 15 mass %, and more preferably up to 10 mass %, with respect to YTMOS as a reference (100 mass %).

The term “metal supporting amount” as used herein refers to the amount occupied by the metallic elements in the supporting promoter.

When the photocatalyst in accordance with an embodiment of the present invention is put to actual use for splitting water, the form of the photocatalyst is not limited to any particular one. Examples of the form include a form in which photocatalyst particles are dispersed in water, a form in which the photocatalyst particles are agglomerated into a molded article and the molded article is placed in water, a form in which a photocatalyst layer is provided on a base material so as to obtain a laminate and the laminate is placed in water, and a form in which the photocatalyst is fixed on a current collector so as to be a photolytic water splitting reaction electrode and placed in water with a counter electrode. In particular, when a photolytic water splitting reaction is performed in a large scale, the photolytic water splitting reaction electrode is preferable from the perspective of being able to promote a water splitting reaction by imparting a bias. As another aspect, by taking advantage of the fact that the photocatalyst in accordance with an embodiment of the present invention is capable of completely splitting water by itself, it is possible to, without imparting a bias, place, in water, a laminate in which a photocatalyst layer including the photocatalyst in accordance with an embodiment of the present invention on a base material is provided or a complex including the photocatalyst in accordance with an embodiment of the present invention. This aspect can provide ease of processing and handling and ease of maintenance, and can suppress the cost when the use is made as an artificial photosynthetic device using a large area. It is thus possible to obtain an industrially advantageous water splitting device, oxygen generation device, hydrogen generation device, or artificial photosynthetic system.

The photolytic water splitting reaction electrode can be prepared by a known method. For example, the photolytic water splitting reaction electrode can be easily prepared by a so-called particle transfer method (Chem. Sci., 2013, 4, 1120-1124). It should be noted here that in the particle transfer method, it is common to produce a photolytic water splitting reaction electrode by the following procedures. That is, photocatalyst particles are placed on a first base material such as glass, so as to obtain a laminate of a photocatalyst layer and a first base material layer. A conductive layer (current collector) is, by vapor deposition or the like, provided on a surface of a photocatalyst layer of the obtained laminate. It should be noted here that the photocatalyst particles on the conductive layer-side surface layer of the photocatalyst layer are fixed to the conductive layer. Then, a second base material is adhered to the surface of the conductive layer, and the conductive layer and the photocatalyst layer are removed from the first base material layer. Part of the photocatalyst particles is fixed to the surface of the conductive layer, and is therefore removed with the conductive layer. As a result, it is possible to obtain a photolytic water splitting reaction electrode having the photocatalyst layer, the conductive layer, and the second base material layer.

Alternatively, as another method, it is possible to obtain a photolytic water splitting reaction electrode by coating the surface of a current collector with a slurry in which photocatalyst particles are dispersed and drying the resultant product. Alternatively, it is possible to obtain a photolytic water splitting reaction electrode by, for example, integrating photocatalyst particles and a current collector by pressure molding or the like. Alternatively, it is possible to immerse a current collector in a slurry in which photocatalyst particles are dispersed and apply a voltage, so as to accumulate the photocatalyst particles on the current collector by electrophoresis.

Alternatively, it is possible to employ a form in which supporting of a promoter is performed in a subsequent step. For example, it is possible to obtain a photolytic water splitting reaction electrode by using an optical semiconductor particles instead of the photocatalyst particles in the above particle transfer method so as to obtain a laminate having an optical semiconductor layer, a conductive layer, and a second base material layer by a similar method, and then supporting, on the surface of the optical semiconductor layer, the oxide particles as a promoter.

The photocatalyst in accordance with an embodiment of the present invention or the above-described photolytic water splitting reaction electrode is immersed in water or an aqueous electrolytic solution, and then the photocatalyst or the photolytic water splitting reaction electrode is irradiated with light so as to perform photolytic water splitting. In this way, hydrogen and/or oxygen can be produced.

For example, the photocatalyst is fixed on a current collector composed of an electric conductor as described above, so as to obtain a photolytic water splitting reaction electrode. Meanwhile, an electric conductor supporting a hydrogen generation catalyst as a counter electrode is used, and light irradiation is performed while liquid or gaseous water is supplied, so as to cause the water splitting reaction to proceed. Providing a potential difference between the electrodes as necessary makes it possible to promote the water splitting reaction. Alternatively, it is possible to use an optical semiconductor supporting a hydrogen generation catalyst as a counter electrode. In this case, as the optical semiconductor, a publicly known optical semiconductor that catalyzes a hydrogen generation reaction can be used.

Meanwhile, the water splitting reaction can be caused to proceed by light irradiation while water is supplied to a fixed article obtained by fixing photocatalyst particles on an insulating base material or to a molded article obtained by pressure molding photocatalyst particles. Alternatively, the water splitting reaction can be caused to proceed by dispersing photocatalyst particles in water or an aqueous electrolytic solution and irradiating the resultant product with light. In this case, the reaction can be promoted by stirring the resultant product as necessary.

The photocatalyst in accordance with an embodiment of the present invention is capable of completely splitting water by itself. Therefore, it is unnecessary to connect an oxygen generation electrode and a hydrogen generation electrode; hydrogen and oxygen can be produced with a means to place the photocatalyst in water and to supply water thereto and a means to take out the hydrogen and/or the oxygen.

Thus, the structure becomes simple and, at the same time, it is possible to perform an operation with half of the area in comparison with a case where an oxygen generation electrode and a hydrogen generation electrode are disposed in parallel. The hydrogen and the oxygen generated can be separated into hydrogen and oxygen by using, for example, a zeolite membrane.

The reaction conditions in production of the hydrogen and/or the oxygen are not particularly limited. For example, the reaction temperature is set to 0° C. to 200° C., and the reaction pressure is set to 2 MPa(G) or less.

The irradiation light is visible light having a wavelength of 650 nm or less or ultraviolet light. Examples of a source of the irradiation light include: the sun; lamps capable of emitting light approximating sunlight such as a xenon lamp and a metal halide lamp; a mercury lamp; and an LED.

### [Recap]

Aspects of the present invention can also be summarized as follows.
<1> A method for producing a photocatalyst having a composition represented by the following general formula (I), including
mixing, with a raw material of the photocatalyst, a flux component at a mass ratio of 0.01 times to 50 times, the flux component being composed of one or more chlorides and/or iodides of at least one selected from Li, Na, K, Rb, Mg, Ca, Sr, and Ba, and calcining a resultant product at 450° C. to 1050° C.:

MₐTi_{b}O_{c}S_{d} (I)
(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).
<2> The method described in <1>, wherein the acid washing is performed after the calcining.
<3> The method described in <1> or <2>, wherein the photocatalyst is for use in complete splitting of water.
<4> A method for producing hydrogen and oxygen, including using a fixed article obtained by fixing a photocatalyst which has been produced by the method described in any of <1> through <3> or using a molded article obtained by molding the photocatalyst, so as to generate the hydrogen and the oxygen.
<5> A method for preparing an electrode, including using a photocatalyst which has been produced by the method described in any of <1> through <3>.
<6> A method for producing hydrogen and oxygen, including using an electrode which has been prepared by the method described in <5>, so as to generate hydrogen and/or oxygen.
<7> A photocatalyst having a composition represented by the following general formula (I), wherein the photocatalyst generates hydrogen in an amount of 100 μmol or more per hour by irradiating the photocatalyst with light using a 300 W xenon lamp (λ>420 nm) in an aqueous methanol solution having a 10 volume % concentration or a 20 mmol/L Na₂S—Na₂SO₃ aqueous buffer solution:

MₐTi_{b}O_{c}S_{d} (I)

(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).
<8> The photocatalyst described in <7>, wherein the photocatalyst is for use in complete splitting of water.
<9> A device which produces hydrogen and oxygen, wherein the device uses a fixed article obtained by fixing the photocatalyst described in <7> or <8> or a molded article obtained by molding the photocatalyst, so as to generate the hydrogen and the oxygen.
<10> An electrode prepared by using the photocatalyst described in <7> or <8>.
<11> A device which produces hydrogen and oxygen, wherein the device uses the electrode described in <10> so as to generate hydrogen and/or oxygen.
<12> A photocatalyst having a composition represented by the following general formula (I), wherein a surface elemental composition ratio of S to Ti (S/Ti) as obtained by XPS measurement is in a range of 0.50 to 1.08:

MₐTi_{b}O_{c}S_{d} (I)

(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).
<13> The photocatalyst described in <12>, wherein the surface elemental composition ratio of S to Ti (S/Ti) as obtained by the XPS measurement is 0.50 to 0.95.
<14> The photocatalyst described in <12> or <13>, wherein the surface elemental composition ratio of S to Ti (S/Ti) as obtained by the XPS measurement is 0.80 to 0.95.
<15> The photocatalyst described in any of <12> through <14>, wherein the photocatalyst is for use in complete splitting of water.
<16> A device which produces hydrogen and oxygen, wherein the device uses a fixed article obtained by fixing the photocatalyst described in any of <12> through <14> or a molded article obtained by molding the photocatalyst, so as to generate the hydrogen and the oxygen.
<17> An electrode prepared by using the photocatalyst described in any of <12> through <14>.
<18> A device which produces hydrogen and oxygen, wherein the device uses the electrode described in <17> so as to generate hydrogen and/or oxygen.

With an embodiment of the present invention, it is thus possible to use the photocatalyst in accordance with an embodiment of the present invention to efficiently produce hydrogen and/or oxygen by a photolytic water splitting reaction.

Therefore, the present invention is expected to contribute to the achievement of the Sustainable Development Goals (SDGs) proposed by the United Nations, for example, Goal 7 “affordable and clean energy”.

### EXAMPLES

The following description will discuss the present invention in more detail with Examples. However, the present invention is not limited to Examples in any way. It should be noted that the values of the various production conditions and evaluation results in Examples have meanings as preferable values for the upper limits and the lower limits in an embodiment of the present invention. The preferable ranges can be defined by combinations of the above-described upper limit values and lower limit values and the values in Examples or combinations of the values in Examples.

### [Environment for Synthesizing Evaluation Photocatalyst]

The raw material of the evaluation photocatalyst and part of an added flux have the property of adsorbing the moisture in the air. This may cause a sealed container to rupture in a calcination step and thus make it impossible to obtain the target evaluation photocatalyst. In the following Examples, the target evaluation photocatalyst was prepared as follows: for preventing the contamination of a small amount of the above-described moisture, the raw materials of the evaluation photocatalyst and the added flux were stored and mixed in a glove box with a dew point of −60° C. or lower in a nitrogen atmosphere for preparation, and contained in a reaction vessel (made of quartz), and calcined.

### [Activation Treatment of Evaluation Photocatalyst and Evaluation of Photocatalytic Activity]

The photocatalyst powders synthesized in the following Examples and Comparative Examples were subjected to any one of activation treatments 1 and 2 and any one of hydrogen generation promoter supporting treatments 1 through 4, and then subjected to hydrogen generation evaluation test 1 or 2. The details of each step are as follows.

### [Activation Treatment]

### <Activation Treatment 1>

Each photocatalyst was subjected to an aerial oxidation treatment as a treatment to promote catalytic activity.

In the aerial oxidation treatment, the photocatalyst was subjected to a heat treatment in the air at 200° C. for 1 hour so as to perform an oxidation treatment on excess sulfur, and the excess sulfur was removed by a water washing treatment.

### <Activation Treatment 2>

Each photocatalyst was subjected to an aerial oxidation treatment and an acid washing treatment as treatments to promote catalytic activity.

In the aerial oxidation treatment, the photocatalyst was subjected to a heat treatment in the air at 200° C. for 1 hour so as to perform an oxidation treatment on excess sulfur, and the excess sulfur was removed by a water washing treatment.

In the acid washing treatment, after the aerial oxidation treatment, 400 mg of each powder was mixed and washed for 15 minutes in sulfuric acid at a concentration of 50 weight %, so as to remove impurities adhered to the surfaces of the particles.

### [Hydrogen Generation Promoter Supporting Treatment]

### <Hydrogen Generation Promoter Supporting Treatment 1>

To a 20 mmol/L Na₂S—Na₂SO₃ aqueous buffer solution to which each photocatalyst powder was added, an aqueous solution of RhCl₃ was added at a concentration so that Rh metal was 2 weight % with respect to each photocatalyst powder. Then, while an inert atmosphere inside the system was maintained, the resultant product was irradiated with visible light for 3 hours. As a light source, a 300 W xenon lamp (λ>420 nm) was used. After the reaction, an unreacted product was removed from each photocatalyst powder by a water washing treatment.

### <Hydrogen Generation Promoter Supporting Treatment 2>

Each photocatalyst powder and an aqueous hexachloroplatinic (IV) acid solution were mixed at a concentration so that Pt metal was 1 weight % with respect to the photocatalyst powder, and NaBH₄ aqueous solution having a concentration of 0.5 mg/mL was further added, and then the resultant product was washed with water.

### <Hydrogen Generation Promoter Supporting Treatment 3>

Each photocatalyst powder and an aqueous hexachloroplatinic (IV) acid solution were mixed at a concentration so that Pt metal was 1 weight % with respect to the photocatalyst powder, and NaBH₄ aqueous solution having a concentration of 0.5 mg/mL was further added, and then the resultant product was washed with water. To a 10 volume % aqueous methanol solution to which the resultant powder was added, a K₂CrO₄ solution was added so that Cr metal was 0.5 weight % with respect to each photocatalyst powder. Then, while an inert atmosphere inside the system was maintained, the resultant product was irradiated with light for 2 hours. As a light source, a 300 W xenon lamp (λ>300 nm) was used. After the reaction, an unreacted product was removed from each photocatalyst powder by a water washing treatment.

### <Hydrogen Generation Promoter Supporting Treatment 4>

Each photocatalyst powder and iridium chloride hydrate were dispersed into distilled water at a ratio so that Ir metal was 0.5 weight % with respect to each photocatalyst powder. The resultant product was heated at 150° C. for 10 minutes with use of a microwave reactor manufactured by Anton Paar. An unreacted product was removed by water washing and filtration. Subsequently, an aqueous hexachloroplatinic (IV) acid solution was mixed with the resultant powder at a concentration so that Pt metal was 1 weight % with respect to each photocatalyst powder. The resultant product was dispersed in ethylene glycol and the resultant product was heated at 150° C. for 10 minutes with use of a microwave reactor manufactured by Anton Paar. An unreacted product was removed by water washing and filtration. To a 10 volume % aqueous methanol solution to which the resultant powder was added, a K₂CrO₄ solution was added so that Cr metal was 0.5 weight % with respect to each photocatalyst powder. Then, while an inert atmosphere inside the system was maintained, the resultant product was irradiated with light for 2 hours. As a light source, a 300 W xenon lamp (λ>300 nm) was used. After the reaction, an unreacted product was removed from each photocatalyst powder by a water washing treatment.

### [Hydrogen Generation Evaluation Test]

### <Hydrogen Generation Evaluation Test 1>

The hydrogen generation evaluation photocatalyst prepared was used to evaluate the photolytic water splitting reaction performance. The photolytic water splitting reaction was performed with use of a closed system reactor that includes an evacuation pump, a circulation pump, a cell for accommodating a photocatalyst fixed article, a gas sampling valve, and a gas chromatograph analyzer (GC). As a light source, a 300 W xenon lamp (λ>420 nm) was used. A water filter was provided between the lamp and the cell to prevent a temperature rise. The cell was cooled from outside with use of cooling water. When the evaluation was made, the inside of the reaction apparatus was degassed several times in advance, and it was confirmed that no air was remaining. The degree of vacuum was set to approximately 4×10⁴ Pa. Subsequently, light irradiation was started, and the amount of gas generated was measured. The analysis conditions were set as follows: the column was a molecular sieve 5A, the carrier gas was argon, and the temperature was 50° C. to 70° C. The test was performed such that, with respect to 300 mg of the hydrogen generation evaluation photocatalyst, 150 mL of 20 mmol/L Na₂S—Na₂SO₃ aqueous buffer solution was sealed in the cell.

### <Hydrogen Generation Evaluation Test 2>

The hydrogen generation evaluation photocatalyst prepared was used to evaluate the photolytic water splitting reaction performance. The photolytic water splitting reaction was performed with use of a closed system reactor that includes an evacuation pump, a circulation pump, a cell for accommodating a photocatalyst fixed article, a gas sampling valve, and a gas chromatograph analyzer (GC). As a light source, a 300 W xenon lamp (λ>420 nm) was used. A water filter was provided between the lamp and the cell to prevent a temperature rise. The cell was cooled from outside with use of cooling water. When the evaluation was made, the inside of the reaction apparatus was degassed several times in advance, and it was confirmed that no air was remaining. The degree of vacuum was set to approximately 4×10⁴ Pa. Subsequently, light irradiation was started, and the amount of gas generated was measured. The analysis conditions were as follows: the column was a molecular sieve 5A, the carrier gas was argon, and the temperature was 50° C. to 70° C. The test was performed such that, with respect to 300 mg of the hydrogen generation evaluation photocatalyst, 150 mL of 10 volume % aqueous methanol solution was sealed in the cell.

### [Evaluation of Purity]

For the evaluation of the purity of the photocatalyst prepared, phase identification of the diffraction diagram obtained with use of an X-ray diffractometer described below was performed, and the value of the intensity ratio was calculated.

### <X-Ray Diffractometer>

Device: SmartLab manufactured by Rigaku
Beam source: Cu-Kα ray
Measurement range: 10° C. to 90° C.

### [Evaluation of S/Ti]

For the evaluation of the surface elemental composition ratio of S to Ti (S/Ti) of the photocatalyst prepared, the ratio was calculated as an area ratio between the peak of emission photoelectron intensity in S2s and the peak of emission photoelectron intensity in Ti2p3/2 which were measured with use of an X-ray photoelectron spectroscopy (XPS) analyzer described below at 10 nm in the depth direction of the photocatalyst.

### <Xps Analyzer>

Device: KRATOS ULTRA2
Beam source: monochromatic Al-Kα ray, output of 15 kV-225 W (15 mA)
Measurement angle: 90° C. (from surface)
Energy correction: C1s=284.6 eV (CC, CH)

### [Synthesis and Evaluation of Photocatalyst Powder]

### Example 1

Gd₂O₃, Gd₂S₃, TiO₂ as raw materials of the photocatalyst were mixed at a 1:2:6 molar ratio, and S in an amount of 5 weight % of the total weight of the raw materials was further mixed to obtain a raw material mixed powder (photocatalyst material). To this raw material mixed powder, LiCl—CaCl₂ mixed flux mixed at a 2:1 molar ratio was added in an amount of 5 times in mass ratio relative to the photocatalyst material. After sufficiently mixing, the resultant product was sealed inside quartz glass while performing vacuum degassing so as to shield the inside from the air. Then, calcination was performed at 700° C. for 24 hours. Because the target photocatalyst and the flux component were present in a mixed manner in the sample obtained, sufficient water washing was performed to remove the flux component, and the resultant product was dried using a vacuum dryer at 40° C. In this way, the target photocatalyst powder A was obtained.

After the earlier-described activation treatment 2 was performed on the photocatalyst powder A, the hydrogen generation promoter supporting treatment 1 was performed and the hydrogen generation evaluation test 1 was performed. It was then confirmed hydrogen was generated at a rate of 450 μmol/h.

### Example 2

After the earlier-described activation treatment 2 was performed on the photocatalyst powder A discussed in Example 1, the hydrogen generation promoter supporting treatment 4 was performed and the hydrogen generation evaluation test 2 was performed. It was then confirmed that hydrogen was generated at a rate of 2500 μmol/h.

### Example 3

The target photocatalyst powder B was obtained as in Example 1 except that the calcination temperature was changed to 950° C.

After the earlier-described activation treatment 2 was performed on the photocatalyst powder B, the hydrogen generation promoter supporting treatment 1 was performed and the hydrogen generation evaluation test 1 was performed. It was then confirmed hydrogen was generated at a rate of 250 μmol/h.

### Example 4

The target photocatalyst powder C was obtained as in Example 1 except that the calcination temperature was changed to 550° C.

After the earlier-described activation treatment 2 was performed on the photocatalyst powder C, the hydrogen generation promoter supporting treatment 1 was performed and the hydrogen generation evaluation test 1 was performed. It was then confirmed hydrogen was generated at a rate of 280 μmol/h.

### Example 5

The target photocatalyst powder D was obtained as in Example 1 except that the LiCl—CaCl₂ mixed flux mixed at a 2:1 molar ratio was added in an amount of 1 time in mass ratio relative to the photocatalyst material.

After the earlier-described activation treatment 2 was performed on the photocatalyst powder D, the hydrogen generation promoter supporting treatment 4 was performed and the hydrogen generation evaluation test 2 was performed. It was then confirmed that hydrogen was generated at a rate of 2400 μmol/h.

### Example 6

The target photocatalyst powder E was obtained as in Example 1 except that the LiCl—CaCl₂ mixed flux mixed at a 2:1 molar ratio was added in an amount of 30 times in mass ratio relative to the photocatalyst material.

After the earlier-described activation treatment 2 was performed on the photocatalyst powder E, the hydrogen generation promoter supporting treatment 4 was performed and the hydrogen generation evaluation test 2 was performed. It was then confirmed that hydrogen was generated at a rate of 2360 μmol/h.

### Example 7

The target photocatalyst powder F was obtained as in Example 1 except that the LiCl—CaCl₂ mixed flux mixed at a 2:1 molar ratio was added in an amount of 0.5 times in mass ratio relative to the photocatalyst material.

After the earlier-described activation treatment 2 was performed on the photocatalyst powder F, the hydrogen generation promoter supporting treatment 4 was performed and the hydrogen generation evaluation test 2 was performed. It was then confirmed that hydrogen was generated at a rate of 1010 μmol/h.

### Example 8

The target photocatalyst powder G was obtained as in Example 1 except that the LiCl—CaCl₂ mixed flux mixed at a 2:1 molar ratio was added in an amount of 0.05 times in mass ratio relative to the photocatalyst material.

After the earlier-described activation treatment 2 was performed on the photocatalyst powder G, the hydrogen generation promoter supporting treatment 4 was performed and the hydrogen generation evaluation test 2 was performed. It was then confirmed that hydrogen was generated at a rate of 275 μmol/h.

### Example 9

The target photocatalyst powder H was obtained as in Example 1 except that the RbCl flux was added in an amount of 5 times in mass ratio relative to the photocatalyst material.

After the earlier-described activation treatment 2 was performed on the photocatalyst powder H, the hydrogen generation promoter supporting treatment 4 was performed and the hydrogen generation evaluation test 2 was performed. It was then confirmed that hydrogen was generated at a rate of 640 μmol/h.

### Example 10

The target photocatalyst powder I was obtained as in Example 1 except that the LiCl—KCl mixed flux mixed at a 1:1 molar ratio was added in an amount of 5 times in mass ratio relative to the photocatalyst material.

After the earlier-described activation treatment 2 was performed on the photocatalyst powder I, the hydrogen generation promoter supporting treatment 4 was performed and the hydrogen generation evaluation test 2 was performed. It was then confirmed that hydrogen was generated at a rate of 535 μmol/h.

### Example 11

The target photocatalyst powder J was obtained as in Example 1 except that the LiCl—NaCl mixed flux mixed at a 1:1 molar ratio was added in an amount of 5 times in mass ratio relative to the photocatalyst material.

After the earlier-described activation treatment 2 was performed on the photocatalyst powder J, the hydrogen generation promoter supporting treatment 4 was performed and the hydrogen generation evaluation test 2 was performed. It was then confirmed that hydrogen was generated at a rate of 110 μmol/h.

### Example 12

The target photocatalyst powder K was obtained as in Example 1 except that the MgCl₂—BaCl₂ mixed flux mixed at a 1:1 molar ratio was added in an amount of 5 times in mass ratio relative to the photocatalyst material and the resultant product was calcined at 720° C.

After the earlier-described activation treatment 1 was performed on the photocatalyst powder K, the hydrogen generation promoter supporting treatment 2 was performed and the hydrogen generation evaluation test 2 was performed. It was then confirmed that hydrogen was generated at a rate of 480 μmol/h.

### Example 13

The target photocatalyst powder L was obtained as in Example 1 except that the MgCl₂—SrCl₂ mixed flux mixed at a 1:1 molar ratio was added in an amount of 5 times in molar ratio relative to the photocatalyst material and the resultant product was calcined at 720° C.

After the earlier-described activation treatment 1 was performed on the photocatalyst powder L, the hydrogen generation promoter supporting treatment 2 was performed and the hydrogen generation evaluation test 2 was performed. It was then confirmed that hydrogen was generated at a rate of 450 μmol/h.

### Example 14

The target photocatalyst powder M was obtained as in Example 1 except that the MgCl₂—CaCl₂ mixed flux mixed at a 1:1 molar ratio was added in an amount of 5 times in molar ratio relative to the photocatalyst material and the resultant product was calcined at 720° C.

After the earlier-described activation treatment 1 was performed on the photocatalyst powder M, the hydrogen generation promoter supporting treatment 2 was performed and the hydrogen generation evaluation test 2 was performed. It was then confirmed that hydrogen was generated at a rate of 310 μmol/h.

### Example 15

The target photocatalyst powder N was obtained as in Example 1 except that Sm₂O₃, Sm₂S₃, and TiO₂ as raw materials of the photocatalyst were mixed at a 1:2:6 molar ratio, and S in an amount of 5 weight % of the total weight of the raw materials was further mixed to obtain a raw material mixed powder (photocatalyst material), and, to this raw material mixed powder, the LiCl—CaCl₂ mixed flux mixed at a 2:1 molar ratio was added in an amount of 5 times in molar ratio relative to the photocatalyst material and the resultant product was calcined at 700° C.

After the earlier-described activation treatment 2 was performed on the photocatalyst powder N, the hydrogen generation promoter supporting treatment 4 was performed and the hydrogen generation evaluation test 2 was performed. It was then confirmed that hydrogen was generated at a rate of 1980 μmol/h.

### Example 16

The target photocatalyst powder O was obtained as in Example 1 except that Er₂₀₃, Er₂S₃, Gd₂O₃, Gd₂S₃, and TiO₂ as raw materials of the photocatalyst were mixed at a 1:2:1:2:12 molar ratio, and S in an amount of 5 weight % of the total weight of the raw materials was further mixed to obtain a raw material mixed powder (photocatalyst material), and, to this raw material mixed powder, the LiCl—CaCl₂ mixed flux mixed at a 2:1 molar ratio was added in an amount of 5 times in mass ratio relative to the photocatalyst material.

After the earlier-described activation treatment 2 was performed on the photocatalyst powder O, the hydrogen generation promoter supporting treatment 4 was performed and the hydrogen generation evaluation test 2 was performed. It was then confirmed that hydrogen was generated at a rate of 1070 μmol/h.

### Example 17

The target photocatalyst powder P was obtained as in Example 1 except that Dy₂O₃, Dy₂S₃, and TiO₂ as raw materials of the photocatalyst were mixed at a 1:2:6 molar ratio, and S in an amount of 5 weight % of the total weight of the raw materials was further mixed to obtain a raw material mixed powder, and, to this raw material mixed powder, the LiCl—CaCl₂ mixed flux mixed at a 2:1 molar ratio was added in an amount of 5 times in mass ratio relative to the photocatalyst material.

After the earlier-described activation treatment 2 was performed on the photocatalyst powder P, the hydrogen generation promoter supporting treatment 4 was performed and the hydrogen generation evaluation test 2 was performed. It was then confirmed that hydrogen was generated at a rate of 280 μmol/h.

### Example 18

The target photocatalyst powder Q was obtained as in Example 1 except that Y₂O₃, Y₂S₃, and TiO₂ as raw materials of the photocatalyst were mixed at a 1:2:6 molar ratio, and S in an amount of 5 weight % of the total weight of the raw materials was further mixed to obtain a raw material mixed powder, and, to this raw material mixed powder, the CaCl₂ flux was added in an amount of 5 times in mass ratio relative to the photocatalyst material.

After the earlier-described activation treatment 1 was performed on the photocatalyst powder Q, the hydrogen generation promoter supporting treatment 2 was performed and the hydrogen generation evaluation test 1 was performed. It was then confirmed that hydrogen was generated at a rate of 390 μmol/h.

### Example 19

The target photocatalyst powder R was obtained das in Example 18 except that the MgCl₂ flux was added in an amount of 5 times in mass ratio relative to the photocatalyst material.

After the earlier-described activation treatment 2 was performed on the photocatalyst powder R, the hydrogen generation promoter supporting treatment 3 was performed and the hydrogen generation evaluation test 2 was performed. It was then confirmed that hydrogen was generated at a rate of 860 μmol/h.

### Example 20

The target photocatalyst powder S was obtained as in Example 1 except that Pr₂O₃, Pr₂S₃, Gd₂O₃, Gd₂S₃, and TiO₂ as raw materials of the photocatalyst were mixed at a 1:2:1:2:12 molar ratio, and S in an amount of 5 weight % of the total weight of the raw materials was further mixed to obtain a raw material mixed powder (photocatalyst material), and, to this raw material mixed powder, the LiCl—CaCl₂ mixed flux mixed at a 2:1 molar ratio was added in an amount of 5 times in mass ratio relative to the photocatalyst material.

After the earlier-described activation treatment 2 was performed on the photocatalyst powder S, the hydrogen generation promoter supporting treatment 4 was performed and the hydrogen generation evaluation test 2 was performed. It was then confirmed that hydrogen was generated at a rate of 382 μmol/h.

### Example 21

The target photocatalyst powder T was obtained as in Example 1 except that Nd₂O₃, Nd₂S₃, Gd₂O₃, Gd₂S₃, and TiO₂ as raw materials of the photocatalyst were mixed at a 1:2:1:2:12 molar ratio, and S in an amount of 5 weight % of the total weight of the raw materials was further mixed to obtain a raw material mixed powder (photocatalyst material), and, to this raw material mixed powder, the LiCl—CaCl₂ mixed flux mixed at a 2:1 molar ratio was added in an amount of 5 times in mass ratio relative to the photocatalyst material.

After the earlier-described activation treatment 2 was performed on the photocatalyst powder T, the hydrogen generation promoter supporting treatment 4 was performed and the hydrogen generation evaluation test 2 was performed. It was then confirmed that hydrogen was generated at a rate of 391 μmol/h.

### Example 22

The target photocatalyst powder U was obtained as in Example 1 except that Ho₂O₃, Ho₂S₃, Gd₂O₃, Gd₂S₃, and TiO₂ as raw materials of the photocatalyst were mixed at a 1:2:1:2:12 molar ratio, and S in an amount of 5 weight % of the total weight of the raw materials was further mixed to obtain a raw material mixed powder (photocatalyst material), and, to this raw material mixed powder, the LiCl—CaCl₂ mixed flux mixed at a 2:1 molar ratio was added in an amount of 5 times in mass ratio relative to the photocatalyst material.

After the earlier-described activation treatment 2 was performed on the photocatalyst powder U, the hydrogen generation promoter supporting treatment 4 was performed and the hydrogen generation evaluation test 2 was performed. It was then confirmed that hydrogen was generated at a rate of 962 μmol/h.

### Example 23

The target photocatalyst powder V was obtained as in Example 1 except that Tb₂O₃, Tb₂S₃, Gd₂O₃, Gd₂S₃, and TiO₂ as raw materials of the photocatalyst were mixed at a 1:2:1:2:12 molar ratio, and S in an amount of 5 weight % of the total weight of the raw materials was further mixed to obtain a raw material mixed powder (photocatalyst material), and, to this raw material mixed powder, the LiCl—CaCl₂ mixed flux mixed at a 2:1 molar ratio was added in an amount of 5 times in mass ratio relative to the photocatalyst material.

After the earlier-described activation treatment 2 was performed on the photocatalyst powder V, the hydrogen generation promoter supporting treatment 4 was performed and the hydrogen generation evaluation test 2 was performed. It was then confirmed that hydrogen was generated at a rate of 435 μmol/h.

### Comparative Example 1

Gd₂O₃, Gd₂S₃, and TiO₂ as raw materials of the photocatalyst were mixed in a 1:2:6 molar ratio, and S in an amount of 5 weight % of the total weight of the raw materials was further mixed to obtain a raw material mixed powder, which was then sealed inside quartz glass while performing vacuum degassing so as to shield the inside from the air. Then, calcination was performed at 1100° C. for 96 hours. In this way, a photocatalyst powder a was obtained.

After the earlier-described activation treatment 2 was performed on the photocatalyst powder a, the hydrogen generation promoter supporting treatment 1 was performed and the hydrogen generation evaluation test 1 was performed. It was then confirmed hydrogen was generated at a rate of 20 μmol/h.

### Comparative Example 2

After the earlier-described activation treatment 2 was performed on the photocatalyst powder a discussed in Comparative Example 1, the hydrogen generation promoter supporting treatment 4 was performed and then the hydrogen generation evaluation test 1 and the hydrogen generation evaluation test 2 were performed. It was then confirmed that hydrogen was generated at rates of 60 μmol/h and 15 μmol/h, respectively.

### Comparative Example 3

After the earlier-described activation treatment 1 was performed on the photocatalyst powder a discussed in Comparative Example 1, the hydrogen generation promoter supporting treatment 2 was performed, and the hydrogen generation evaluation test 1 and the hydrogen generation evaluation test 2 were performed. It was then confirmed that hydrogen was generated at rates of 10 μmol/h and 3 μmol/h, respectively.

### Comparative Example 4

The photocatalyst powder b was obtained as in Comparative Example 1 except that the calcination temperature was set to 800° C.

After the earlier-described activation treatment 2 was performed on the photocatalyst powder b, the hydrogen generation promoter supporting treatment 1 was performed and the hydrogen generation evaluation test 1 was performed. It was then confirmed hydrogen was generated at a rate of 40 μmol/h.

### Comparative Example 5

The target photocatalyst powder c was obtained as in Example 1 except that the calcination temperature was set to 400° C.

After the earlier-described activation treatment 2 was performed on the photocatalyst powder c, the hydrogen generation promoter supporting treatment 1 was performed and the hydrogen generation evaluation test 1 was performed. It was then confirmed hydrogen was generated at a rate of 10 μmol/h.

### Comparative Example 6

The target photocatalyst powder d was obtained as in Example 1 except that the calcination temperature was set to 1200° C.

After the earlier-described activation treatment 2 was performed on the photocatalyst powder d, the hydrogen generation promoter supporting treatment 1 was performed and the hydrogen generation evaluation test 1 was performed. It was then confirmed hydrogen was generated at a rate of 40 μmol/h.

### Comparative Example 7

The target photocatalyst powder e was obtained as in Example 1 except that the LiCl—CaCl₂ mixed flux was added in an amount of 0.005 times in mass ratio relative to the photocatalyst material and the resultant product was calcined at 700° C.

After the earlier-described activation treatment 2 was performed on the photocatalyst powder e, the hydrogen generation promoter supporting treatment 4 was performed and the hydrogen generation evaluation test 2 was performed. It was then confirmed that hydrogen was generated at a rate of 15 μmol/h.

### Comparative Example 8

The target photocatalyst powder f was obtained as in Example 15 except that the CsCl flux was added in an amount of 5 times in mass ratio relative to the photocatalyst material.

After the earlier-described activation treatment 2 was performed on the photocatalyst powder f, the hydrogen generation promoter supporting treatment 4 was performed and the hydrogen generation evaluation test 2 was performed. It was then confirmed that hydrogen was generated at a rate of 20 μmol/h.

### Comparative Example 9

The target photocatalyst powder g was obtained as in Example 1 except that the CsCl flux was added in an amount of 5 times in molar ratio relative to the photocatalyst material and the resultant product was calcined at 700° C.

After the earlier-described activation treatment 2 was performed on the photocatalyst powder g, the hydrogen generation promoter supporting treatment 4 was performed and the hydrogen generation evaluation test 2 was performed. It was then confirmed that hydrogen was generated at a rate of 10 μmol/h.

### Comparative Example 10

Gd₂O₃, TiO₂, and TiS₂ as raw materials of the photocatalyst were mixed at a 1:1:1 molar ratio, and S in an amount of 10 mol % of the total weight of the raw material was further mixed to obtain a raw material mixed powder (photocatalyst material). To this raw material mixed powder, the CsCl flux was added in an amount of 5 times in molar ratio relative to the photocatalyst material. After sufficiently mixing, H₂S was allowed to flow through a tubular furnace from which the air was removed, and calcination was performed at 875° C. for 5 hours. Because the target photocatalyst and the flux component were present in a mixed manner in the sample obtained, sufficient water washing was performed to remove the flux component, and the resultant product was dried using a vacuum dryer at 40° C. In this way, the target photocatalyst powder h was obtained.

After the earlier-described activation treatment 2 was performed on the photocatalyst powder h, the hydrogen generation promoter supporting treatment 2 was performed and the hydrogen generation evaluation test 2 was performed. It was then confirmed that hydrogen was generated at a rate of 25 μmol/h.

### Comparative Example 11

Y₂O₃, Y₂S₃, TiO₂ as raw materials of the photocatalyst were mixed in a 1:2:6 molar ratio, and S in an amount of 5 weight % of the total weight of the raw materials was further mixed to obtain a raw material mixed powder, which was then sealed inside quartz glass while performing vacuum degassing so as to shield the inside from the air. Then, calcination was performed at 800° C. for 96 hours. In this way, a photocatalyst powder i was obtained.

After the earlier-described activation treatment 1 was performed on the photocatalyst powder i, the hydrogen generation promoter supporting treatment 2 was performed and the hydrogen generation evaluation test 1 was performed. It was then confirmed that hydrogen was generated at a rate of 90 μmol/h.

### Comparative Example 12

After the earlier-described activation treatment 2 was performed on the photocatalyst powder i discussed in Comparative Example 11, the hydrogen generation promoter supporting treatment 3 was performed and the hydrogen generation evaluation test 2 was performed. It was then confirmed that hydrogen was generated at a rate of 10 μmol/h.

Table 1 summarizes the purity (mass %) of the photocatalysts obtained in Examples 1 through 23 and Comparative Examples 1 through 12, the conditions for producing the photocatalysts, the hydrogen generation evaluation tests, and the results of the evaluations of the surface elemental composition ratios (S/Ti).

TABLE 1

| | | | | | Amount of | | | | | | | | | |
|---|---|---|---|---|---|---|---|---|---|---|---|---|---|---|
| | | | | | flux with | | | | Activation | | | | | |
| | | | | | respect to | | Calci- | | treatment | | | | | |
| | | | | | photocatalyst | | nation | | | Acid | | Hydrogen | Amount of | |
| | | Photo- | | | material | | temper- | | | washing | Promoter | generation | hydrogen | XPS |
| | | catalyst | M | | (weight | | ature | Purity | | time | supporting | evaluation | generation | result |
| | | Powder | element | Flux | ratio) | | (° C.) | Wt. % | Method | (min.) | treatment | test | (μmol/h) | S/Ti |
| Examples | 1 | A | Gd | LiCl—CaCl₂ | 5 | times | 700 | >98 | 2 | 15 | 1 | 1 | 450 | 0.82 |
| | 2 | A | Gd | LiCl—CaCl₂ | 5 | times | 700 | >98 | 2 | 15 | 4 | 2 | 2500 | 0.82 |
| | 3 | B | Gd | LiCl—CaCl₂ | 5 | times | 950 | >98 | 2 | 15 | 1 | 1 | 250 | 1.04 |
| | 4 | C | Gd | LiCl—CaCl₂ | 5 | times | 550 | >98 | 2 | 15 | 1 | 1 | 280 | 0.75 |
| | 5 | D | Gd | LiCl—CaCl₂ | 1 | times | 700 | >98 | 2 | 15 | 4 | 2 | 2400 | 0.86 |
| | 6 | E | Gd | LiCl—CaCl₂ | 30 | times | 700 | >98 | 2 | 15 | 4 | 2 | 2360 | 0.88 |
| | 7 | F | Gd | LiCl—CaCl₂ | 0.5 | times | 700 | >98 | 2 | 15 | 4 | 2 | 1010 | 0.82 |
| | 8 | G | Gd | LiCl—CaCl₂ | 0.05 | times | 700 | >98 | 2 | 15 | 4 | 2 | 275 | |
| | 9 | H | Gd | RbCl | 5 | times | 700 | >98 | 2 | 15 | 4 | 2 | 640 | |
| | 10 | I | Gd | LiCl—KCl | 5 | times | 700 | >98 | 2 | 15 | 4 | 2 | 535 | |
| | 11 | J | Gd | LiCl—NaCl | 5 | times | 700 | >98 | 2 | 15 | 4 | 2 | 110 | |
| | 12 | K | Gd | MgCl₂—BaCl₂ | 5 | times | 720 | >98 | 1 | — | 2 | 2 | 480 | |
| | 13 | L | Gd | MgCl₂—SrCl₂ | 5 | times | 720 | >98 | 1 | — | 2 | 2 | 450 | |
| | 14 | M | Gd | MgCl₂—CaCl₂ | 5 | times | 720 | >98 | 1 | — | 2 | 2 | 310 | |
| | 15 | N | Sm | LiCl—CaCl₂ | 5 | times | 700 | >98 | 2 | 15 | 4 | 2 | 1980 | 0.84 |
| | 16 | O | Er•Gd | LiCl—CaCl₂ | 5 | times | 700 | >98 | 2 | 15 | 4 | 2 | 1070 | 0.86 |
| | 17 | P | Dy | LiCl—CaCl₂ | 5 | times | 700 | >98 | 2 | 15 | 4 | 2 | 280 | |
| | 18 | Q | Y | CaCl₂ | 5 | times | 700 | >98 | 1 | — | 2 | 1 | 390 | |
| | 19 | R | Y | MgCl₂ | 5 | times | 700 | >98 | 2 | 15 | 3 | 2 | 860 | |
| | 20 | S | Pr•Gd | LiCl—CaCl₂ | 5 | times | 700 | >98 | 2 | 15 | 4 | 4 | 382 | |
| | 21 | T | Nd•Gd | LiCl—CaCl₂ | 5 | times | 700 | >98 | 2 | 15 | 4 | 2 | 391 | |
| | 22 | U | Ho•Gd | LiCl—CaCl₂ | 5 | times | 700 | >98 | 2 | 15 | 4 | 2 | 962 | |
| | 23 | V | Tb•Gd | LiCl—CaCl₂ | 5 | times | 700 | >98 | 2 | 15 | 4 | 2 | 435 | |
| Comparative | 1 | a | Gd | N/A | — | | 1100 | >98 | 2 | 15 | 1 | 1 | 20 | 1.14 |
| Examples | 2 | a | Gd | N/A | — | | 1100 | >98 | 2 | 15 | 4 | 1, 2 | 60, 15 | 1.14 |
| | 3 | a | Gd | N/A | — | | 1100 | >98 | 1 | — | 2 | 1, 2 | 10, 3 | 1.14 |
| | 4 | b | Gd | N/A | — | | 800 | 60 | 2 | 15 | 1 | 1 | 40 | |
| | 5 | c | Gd | LiCl—CaCl₂ | 5 | times | 400 | 30 | 2 | 15 | 1 | 1 | 10 | |
| | 6 | d | Gd | LiCl—CaCl₂ | 5 | times | 1200 | 90 | 2 | 15 | 1 | 1 | 40 | |
| | 7 | e | Gd | LiCl—CaCl₂ | 0.005 | times | 700 | 50 | 2 | 15 | 4 | 2 | 15 | |
| | 8 | f | Sm | CsCl | 5 | times | 700 | >98 | 2 | 15 | 4 | 2 | 20 | 1.21 |
| | 9 | g | Gd | CsCl | 5 | times | 700 | >98 | 2 | 15 | 4 | 2 | 10 | |
| | 10 | h | Gd | CsCl | 5 | times | 875 | >98 | 2 | 15 | 2 | 2 | 25 | |

| | | | | | | | | | | | | |
|---|---|---|---|---|---|---|---|---|---|---|---|---|
| 11 | i | Y | N/A | — | 800 | >98 | 1 | — | 2 | 1 | 90 | 1.09 |
| 12 | i | Y | N/A | — | 800 | >98 | 2 | 15 | 3 | 2 | 10 | 1.09 |

### Discussion

Table 1 reveals the following.

Comparative Example 1 shows the results of the hydrogen generation evaluation test 1 obtained by the conventional solid-phase synthesis method (J. Phys. Chem. B 2004, 108, 8, 2637-2642) that uses no flux. While Comparative Example 4, in which the calcination temperature was decreased, shows a tendency that the hydrogen is generated at an increased rate, the purity was considerably decreased (Table 1). This is because the decrease in the calcination temperature prevents the production reaction of Gd₂Ti₂O₅S₂ from sufficiently proceeding.

Meanwhile, in Example 1, although the reaction temperature is lower in comparison with those in Comparative Examples 1 and 4, the target Gd₂Ti₂O₅S₂ was obtained in high purity (see Table 1), and the hydrogen generation rate in the hydrogen generation evaluation test 1 was considerably increased.

Examples 1, 3, and 4 and Comparative Examples 5 and 6 revealed the tendency that the calcination temperature causes the hydrogen generation rate in the hydrogen generation evaluation test 1 to remarkably change. From this, it is considered that if the calcination temperature is excessively low, the flux component added does not melt and does not function as a flux, and thus the reaction does not sufficiently proceed, and the purity of the target Gd₂Ti₂O₅S₂ decreases (see the “purity” column of Table 1), and therefore good photocatalytic activity cannot be obtained. In contrast, it is considered that if the calcination temperature is excessively high, an oxide impurity phase is generated and thus the purity is decreased, and therefore a decrease in the photocatalytic activity likewise occurs. Hence, the calcination temperature is preferably 450° C. to 1050° C. and more preferably 500° C. to 1000° C.

Examples 2, 5, 6, 7, and 8 and Comparative Example 7 revealed the tendency that the amount of the flux added to the photocatalyst material causes the hydrogen generation rate in the hydrogen generation evaluation test 2 to remarkably change. From this, it is considered that if the amount of a flux is not sufficient, the melted flux is not spread through the entire raw material, and thus the reaction does not sufficiently proceed, and the purity of the target Gd₂Ti₂O₅S₂ decreases (see the “purity” column of Table 1), and therefore good photocatalytic activity cannot be obtained. Hence, the mass ratio of the flux to the photocatalyst in the mixture is 0.01 or more, and more preferably 0.1 or more. In contrast, even when the mass ratio of the flux in the mixture is extremely high as in Example 6, there is no negative effect on the photocatalyst performance. However, when the reaction vessel is of a certain volume, a large amount of the flux causes the encapsulation amount of the photocatalyst material to be low. Thus, the amount of the target photocatalyst also becomes small. Thus, the mass ratio of the flux in the mixture in handling is preferably 50 or less, and more preferably 40 or less.

Examples 2 and 9 through 14 and Comparative Examples 2, 3, and 9 revealed the effects of the types of the flux added to the photocatalyst material. These results show that as the type of flux to be added to the raw material of Ln₂Ti₂O₅S₂, many alkali or alkali earth chloride fluxes such as LiCl, NaCl, KCl, RbCl, MgCl₂, CaCl₂), SrCl₂ and BaCl₂ were effective. In addition, among existing studies, there has been a study relating to the synthesis of Sm₂Ti₂O₅S₂ using CsCl which is an alkali chloride flux (J. Phys. Chem. C 2018, 122, 13492-13499). Preparation was performed under the same conditions in Comparative Example 10, and the hydrogen generation rate was poor. It was therefore confirmed that not all of the typical flux materials are effective as the flux in the present invention, but it is important to use LiCl, NaCl, KCl, RbCl, MgCl₂, CaCl₂), SrCl₂ and BaCl₂.

Although the earlier-described effective types of flux were applied to various Ln₂Ti₂O₅S₂ in Examples 2 and 15 through 17 and Comparative Examples 8 and 9, the Ln element can be applied to not only Gd but also to various elements such as Sm, Er, and Dy, and is thus considered to be applicable to lanthanoid elements (Pr, Nd, Pm, Sm, Eu, Gd, Tb, Dy, Ho, Er, and Tm).

In addition, in the results of Y₂Ti₂O₅S₂ shown in Examples 18 and 19 and Comparative Examples 11 and 12, the hydrogen generation rate is remarkably improved. It was therefore found that the Y elements are also applicable to the present invention.

The above confirmed that a photocatalyst exhibits excellent hydrogen generation activity if the photocatalyst has a composition represented by the following general formula (I) and is produced by, at the synthesis of the photocatalyst, mixing one or more flux components with the photocatalyst material at a certain ratio, the flux components being selected from chlorides and/or iodides of Li, Na, K, Rb, Mg, Ca, Sr, and Ba and calcining a resultant product at a certain temperature:

MₐTi_{b}O_{c}S_{d} (I)

(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).

1. A method for producing a photocatalyst having a composition represented by the following general formula (I), comprising
mixing, with a raw material of the photocatalyst, a flux component at a mass ratio of 0.01 times to 50 times, the flux component being composed of one or more chlorides and/or iodides of at least one selected from Li, Na, K, Rb, Mg, Ca, Sr, and Ba, and calcining a resultant product at 450° C. to 1050° C.:
MₐTi_{b}O_{c}S_{d} (I)
(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).

2. The method according to claim 1, wherein the acid washing is performed after the calcining.

3. The method according to claim 1, wherein the photocatalyst is for use in complete splitting of water.

4. A method for producing hydrogen and oxygen, comprising using a fixed article obtained by fixing a photocatalyst which has been produced by the method according to claim 1 or using a molded article obtained by molding the photocatalyst, so as to generate the hydrogen and the oxygen.

5. A method for preparing an electrode, comprising using a photocatalyst which has been produced by the method according to claim 1.

6. A method for producing hydrogen and oxygen, comprising using an electrode which has been prepared by the method according to claim 5, so as to generate hydrogen and/or oxygen.

7. A photocatalyst having a composition represented by the following general formula (I), wherein the photocatalyst generates hydrogen in an amount of 100 μmol or more per hour by irradiating the photocatalyst with light using a 300 W xenon lamp (λ>420 nm) in an aqueous methanol solution having a 10 volume % concentration or a 20 mmol/L Na₂S—Na₂SO₃ aqueous buffer solution:
MₐTi_{b}O_{c}S_{d} (I)
(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).

8. The photocatalyst according to claim 7, wherein the photocatalyst is for use in complete splitting of water.

9. A device which produces hydrogen and oxygen, wherein the device uses a fixed article obtained by fixing the photocatalyst according to claim 7 or a molded article obtained by molding the photocatalyst, so as to generate the hydrogen and the oxygen.

10. An electrode prepared by using the photocatalyst according to claim 7.

11. A device which produces hydrogen and oxygen, wherein the device uses the electrode according to claim 10 so as to generate hydrogen and/or oxygen.

12. A photocatalyst having a composition represented by the following general formula (I), wherein a surface elemental composition ratio of S to Ti (S/Ti) as obtained by XPS measurement is in a range of 0.50 to 1.08:
MₐTi_{b}O_{c}S_{d} (I)
(where M is a combination of one or more selected from Pr, Nd, Pm, Sm, Eu, Gd, Tb, Dy, Ho, Er, Tm, and Y, a is a number of 1.7 to 2.3, b is a number of 2, c is a number of 4.7 to 5.3, and d is a number of 1.7 to 2.3).

13. The photocatalyst according to claim 12, wherein the surface elemental composition ratio of S to Ti (S/Ti) as obtained by the XPS measurement is 0.50 to 0.95.

14. The photocatalyst according to claim 12, wherein the surface elemental composition ratio of S to Ti (S/Ti) as obtained by the XPS measurement is 0.80 to 0.95.

15. The photocatalyst according to claim 12, wherein the photocatalyst is for use in complete splitting of water.

16. A device which produces hydrogen and oxygen, wherein the device uses a fixed article obtained by fixing the photocatalyst according to claim 12 or a molded article obtained by molding the photocatalyst, so as to generate the hydrogen and the oxygen.

17. An electrode prepared by using the photocatalyst according to claim 12.

18. A device which produces hydrogen and oxygen, wherein the device uses the electrode according to claim 17 so as to generate hydrogen and/or oxygen.
